(19) United States
(12) Patent Application Publication
(10) Pub. No.: US 2012/0255968 A1
(43) Pub. Date: Oct. 11, 2012

(54) GRAVITY FEED CARTON FOR CEREAL BARS

(75) Inventors: ALLISON NICOLE KARAY, CARY, IL (US); JULIE ALLYSON SALIBA, CHICAGO, IL (US); LINDSAY MARIE DELANEY, CHICAGO, IL (US); RACHEL LEVIN FIELY, CHICAGO, IL (US)

(73) Assignee: THE QUAKER OATS COMPANY, CHICAGO, IL (US)

(21) Appl. No.: 13/440,047

(22) Filed: Apr. 5, 2012

Related U.S. Application Data
(60) Provisional application No. 61/473,003, filed on Apr. 7, 2011.

(51) Int. Cl. B65D 83/00; B65G 59/00

(52) U.S. Cl. 221/155; 221/282

(57) ABSTRACT

A carton for dispensing consumable wrapped products, such as cereal bars, power bars, granola bars or other snacks. The carton may include a front panel, a back panel, opposing side panels, a top panel and a bottom panel. The carton may include a perforated opening portion that is removable from the carton and defines an opening through which one or more products may be dispensed. The carton may also include an inventory window that allows visual access to one or more products within the carton.

### CROSS REFERENCE TO RELATED APPLICATIONS

This Application claims priority to U.S. Provisional Application Ser. No. 61/473,003, filed Apr. 7, 2011. This application is incorporated by reference in its entirety.

### FIELD OF THE INVENTION

This invention relates to improved packaging for consumable wrapped products, such as cereal bars, power bars, granola bars or other snack bars.

### BACKGROUND

Generally, packaging for consumable wrapped products, such as cereal bars, power bars, granola bars or other snack bars consists of a container that may be opened and closed to allow consumers access to the products inside the container. The packaging is generally made of a paperboard material that does not provide visual access to the contents of the container. Moreover, this packaging does not permit products to automatically feed to a dispensing opening. A need exists for an improved container or carton for dispensing consumable wrapped products.

### SUMMARY OF THE INVENTION

An object of this invention described herein is to provide a carton that allows a consumer visual access to the amount of product contained within the carton. Another object of this invention is to direct the consumer to an opening in the carton where product is dispensed. A further object of this invention is to provide a carton wherein the product contained therein automatically feeds to a dispensing opening such that once one product is removed the next-in-line product moves to the dispensing opening.

In one aspect of the invention, a carton may have a front panel, a back panel, two opposing side panels, a top panel, and a bottom panel. The front panel, back panel, opposing side panels, top panel, and bottom panel may be defined on a carton blank that is folded together to form the carton. The carton may contain an inventory window that allows a consumer visual access to product contained within the carton. In at least one embodiment, the inventory window allows the consumer to determine the number of product remaining in the carton. The inventory window may be made of a clear, transparent, or semi-transparent material that allows the consumer to see the product in the carton.

In another aspect of the invention, the carton may include information directing the consumer to an opening within the carton from which product may be dispensed. In at least one embodiment, the inventory window directs the consumer to the opening of the carton. The inventory window may be any suitable shape or size, including an arrow pointing toward the opening of the carton.

In yet a further aspect of the invention, the carton is configured such that product stored in the carton are arranged to self-feed to the dispensing opening in the carton.

### BRIEF DESCRIPTION OF THE DRAWINGS

FIG. 1 is a perspective view of a carton in accordance with at least one embodiment of the present invention;

FIG. 2 is a top view of a carton blank in accordance with one or more aspects of the present invention.

FIG. 3 is an alternative top view of a carton blank in accordance with one or more aspects of the invention.

### DETAILED DESCRIPTION OF THE INVENTION

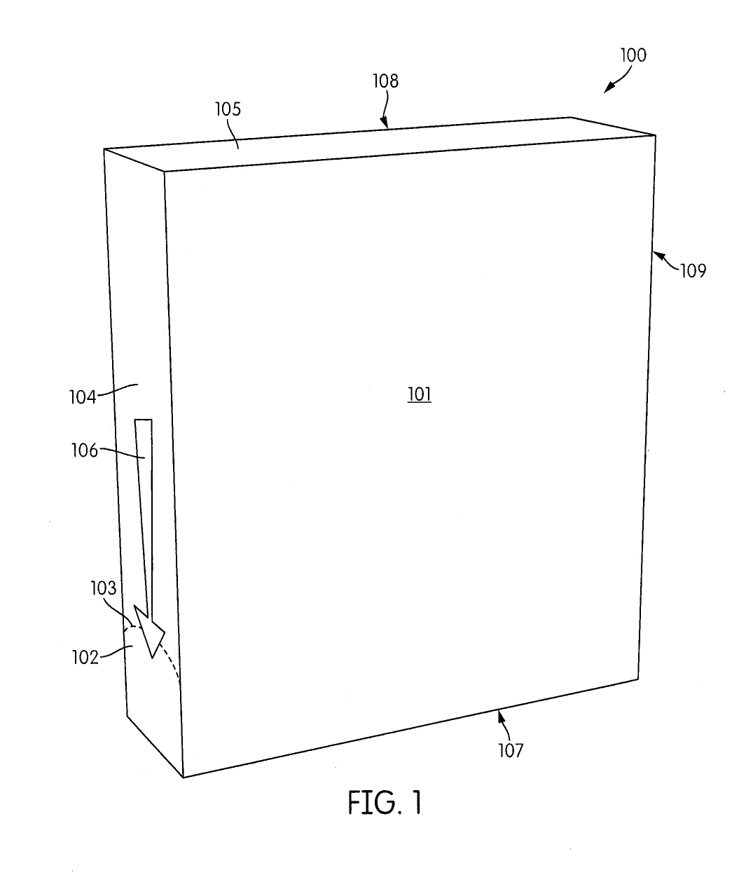

Referring to FIG. 1, there is depicted a carton 100 that may be used to contain products, such as snack bars, in an oriented manner. The carton 100 may define a plurality of panels, including a front panel 101, a back panel 108, opposing side panels 104 and 109, a top panel 105 and a bottom panel 107. Each of the panels may contain graphics or information, including product or consumer information. The carton 100 may be configured to hold any type of product, including consumable wrapped products, such as cereal bars, power bars, granola bars or other snack bars. The carton 100 may be any size or shape and may be configured to hold any number of products. For example, the carton 100 may be configured to hold 8 snack bars, 10 snack bars, 20 snack bars, or the like.

The carton 100 may include one or more openings for removing product from inside the carton 100. In at least one embodiment, the first side panel 104 may include a perforated opening portion 102, defined by a perforation 103. The perforation 103 may extend partially through the thickness of the carton or extend through the entire thickness of the carton. The perforation 103 may be formed by any method or technique used to create a perforation 103 in a carton or paperboard material, including laser scoring. The perforation 103 permits the perforated portion 102 of the carton 100 defined by the perforation 103 to be easily removed by a consumer, as understood in the art. Once the perforated portion 102 that defines the opening is removed, the opening is sufficiently sized and shaped to permit product to be removed. Any amount of product may be removed from the opening. For example, in at least one embodiment, at least one bar may be pulled out from the carton through the opening. In this embodiment, bars positioned above and on top of the removed bar will then move downward toward the opening and the next-in-line bar will then be in a position to be removed through the opening. As each bar is removed, and after each bar is removed, the consumer will be able to visibly observe through an inventory window, described below, the number of bars remaining in the carton. This will give the consumer the opportunity to determine whether the carton is nearly depleted of bars and therefore nearly ready to be replaced with a new carton full of bars. In this embodiment, the bars may be organized or stacked in the carton in numerous ways and yet still feed toward the opening after one or more bars are removed through the opening. In at least one embodiment, one or more of the panels will create an opening. For example, the top panel 105 or bottom panel 107 may open to allow consumers access to the product within the carton 100.

In at least one embodiment, the carton 100 includes an inventory window 106. The inventory window 106 may be positioned anywhere on the carton 100. In at least one embodiment, the inventory window 106 is located on the first side panel 104 and positioned above the opening portion 102 to permit a consumer to visually determine how many snack bars remain in the carton 100. The inventory window 106 may be directly adjacent the opening portion 102, above the opening portion 102, or may overlap with part of the opening portion 102. The inventory window 106 can be sized and shaped in a variety of configurations suitable for allowing a consumer visual access to product within the carton 100. In at least one embodiment, the inventory window 106 is in the shape of an arrow. In this embodiment, the arrow shaped design not only permits the product to be seen in the carton 100 to inform a consumer how much product is left in the carton 100, the arrow also directs the consumer to the opening 102 where the product is dispensed. The inventory window 106 may be made of any suitable material. In at least one embodiment, the inventory window 106 is formed from clear, transparent, or semi-transparent material that is suitable for containing wrapped products, such as snack bars.

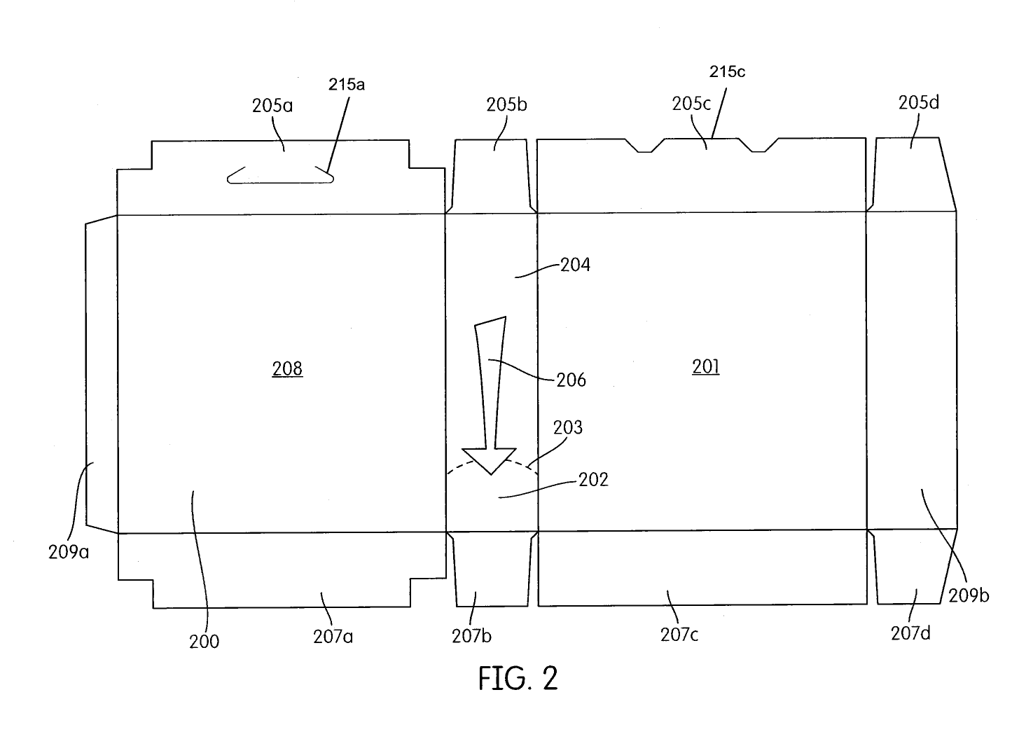

Referring to FIG. 2, there is depicted a carton blank 200 of the carton 100 from FIG. 1. The carton blank 200 illustrates the various panels of the carton 100 and shows the perforated opening portion 202 in a side panel defined by the perforation 203. The carton blank 200 also depicts an inventory window 206 positioned on a first side panel 204. The panels of the carton blank 200, including a front panel 201, a back panel 208, opposing side panels 204 and 209, a top panel 205 and a bottom panel 207 of the carton blank 200 may be folded together to form the carton 100. The carton blank 200 may include scores or fold lines that enable sections of the carton blank 200 to fold. The scores may be cut at a depth of approximately 70-90% of the thickness of the carton blank 200.

The panels, such as the top panel 205, bottom panel 207, and side panel 209 may include panel portions that connect together to form each panel. For example, panel portions 205a, 205b, 205c, and 205d may connect together to form the top panel 205 and panel portions 207a, 207b, 207c, and 207d may connect together to form the bottom panel 207. Additionally, panel portions 209a and 209b may connect together to form the second side panel 209. The panels and panel portions of the carton 100 may be held together in any suitable manner. For example, an adhesive may be used to hold the panels and/or panel portions together.

The carton 100 and carton blank 200 may be any suitable size and dimensions for holding product. For example, the height of the carton may be 5 and 9/16 inches, the width of the carton 100 may be 1 and ⅝ inches, and the length of the carton may be 5 and ¾ inches. The carton blank 200 may also include scores or perforations and/or tabs or projections to allow one or more of the panel portions to engage with each other and to allow one of the panels, such as a side panel 109, the top panel 105, or the bottom panel 107 to open and close. For example, top panel 205a may include a perforation or scored opening 215a that receives a corresponding tab 215c defined on top panel 205a, which allows the panels 205a and 205c to engage each other. When the tab 215c is disengaged from the opening 215a, the top panel 205 may be opened. When tab 215c is engaged with the opening 215a, the top panel 205 is closed.

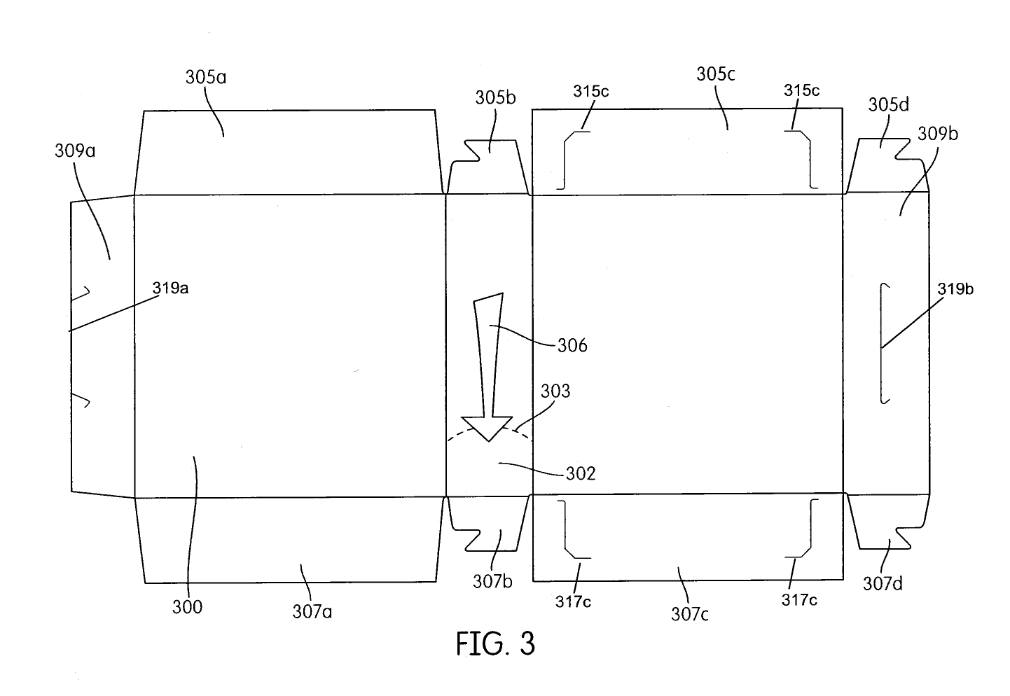

Referring to FIG. 3, there is depicted an alternative carton blank 300 illustrating a perforated opening portion 302 in a side panel defined by the perforation 303. The carton blank 300 also depicts an inventory window 306 on a side panel 309. The dimensions of the carton blank 300 may differ from the dimensions of carton blank 200. For example, the side panel portions 209a and 209b may have width dimensions of 9/16 inches and 1 and 19/32 inches, respectively, while side panel portions 309a and 309b may have width dimensions of 1 and 3/16 and 1 and ⅝, respectively. Additionally, one or more panel portions, such as 305b, 307b, 305d, and 307d may include projections and/or apertures for engaging with each other or other panel portions. For example, the projections on panel portions 305b and 305d may engage with apertures 315c to keep panels 305b, 305c, and 305d together. Similarly, the projections on panel portions 307b and 307d may engage with apertures 317c to keep panels 307b, 307c, and 307d together. The panel portions of carton blank 300 may be folded together to form the carton 100 and an adhesive may be used to hold the panels in place. Additionally, the carton blank 300 may also include scores or perforations and/or tabs or projections to allow one or more of the panel portions to engage with each other and to allow one of the panels, such as a side panel 109, the top panel 105, or the bottom panel 107 to open and close. For example, side panel portion 309a many include a tab 319a, which is defined by scores or perforations, that engages a scored opening 319b on side panel portion 309b. When the tab 319a is disengaged from the opening 319b, the side panel portions 309a and 309b may be opened. When tab 319a is engaged with the opening 319b, the side panel portions 309a and 309b are closed.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims. Additionally, one of ordinary skill in the art will appreciate that the steps illustrated in the illustrative figures may be performed in other than the recited order, and that one or more steps illustrated may be optional in accordance with aspects of the disclosure.

What is claimed is:

1. A carton containing a food product comprising:
a front panel;
a back panel;
a first side panel and a second side panel, wherein the first side panel defines a removable perforated opening portion and an inventory window;
a top panel; and
a bottom panel.

2. The carton of claim 1, wherein the inventory window is positioned above the removable perforated opening portion.

3. The carton of claim 2, wherein the inventory window is in a shape of an arrow.

4. The carton of claim 3, wherein a tip of the arrow points to the perforated opening portion.

5. The carton of claim 1, wherein the inventory window is transparent to provide visual access to product within the carton.

6. The carton of claim 1, wherein the carton is configured to hold a plurality of food products with each product stacked on top of one another.

7. The carton of claim 6, wherein the plurality of food products are one or more of cereal bars, power bars, granola bars, or snack bars.

8. The carton of claim 7, wherein the plurality of food products are configured to be dispensed from an opening defined on the first side panel when the removable perforated opening portion is removed.

9. The carton of claim 8, wherein when one of the plurality of food products is dispensed from the opening defined on the first side panel, a next-in-line product moves toward the opening.

10. The carton of claim 9, wherein the top panel is connected to the front panel, the back panel, the first side panel and the second side panel, and wherein the bottom panel is connected to the front panel, the back panel, the first side panel, and the second side panel, and wherein the panels are connected together via an adhesive.

11. A carton containing a food product comprising:
a front panel;
a back panel;
a first side panel and a second side panel, wherein the first side panel defines a removable perforated opening portion and an inventory window positioned adjacent and above the perforated opening portion;
a top panel; and
a bottom panel,
wherein the top panel is connected to the front panel, the back panel, the first side panel and the second side panel, and
wherein the bottom panel is connected to the front panel, the back panel, the first side panel, and the second side panel.

12. The carton of claim 11, wherein a shape of the inventory window directs a consumer to the removable perforated opening portion.

13. The carton of claim 12, wherein the inventory window is in a shape of an arrow.

14. The carton of claim 11, wherein the inventory window is transparent to provide consumers with visual access to product contained within the carton.

15. The carton of claim 11, wherein the inventory window permits visual access to the amount of product contained in the carton.

16. The carton of claim 13, wherein a tip of the arrow points to the perforated opening portion.

17. A carton containing a food product comprising:
a front panel;
a back panel;
a first side panel and a second side panel, wherein the first side panel defines a removable perforated opening portion and a transparent inventory window positioned above the perforated opening portion;
a top panel; and
a bottom panel,
wherein the top panel is connected to the front panel, the back panel, the first side panel and the second side panel, and
wherein the bottom panel is connected to the front panel, the back panel, the first side panel, and the second side panel.

18. The carton of claim 17, wherein a shape of the inventory window directs a consumer to the removable perforated opening portion.

19. The carton of claim 17, wherein the inventory window is in a shape of an arrow having a tip pointing to the removable perforated opening portion.

20. The carton of claim 17, wherein product is configured to be dispensed from an opening defined in the first side panel when the removable perforated opening portion is removed, and wherein when one of the product is dispensed from the opening, a next-in-line product moves toward the opening.
